(19) United States
(12) Patent Application Publication
(10) Pub. No.: US 2021/0143910 A1
(43) Pub. Date: May 13, 2021

(54) METHOD OF SEGMENTING AN ACCESS NETWORK OF A HYBRID FIBER COAXIAL NETWORK

(71) Applicant: TECHNETIX B.V., Veenendaal (NL)

(72) Inventors: Jan ARIESEN, Veenendaal (NL); Gerrit BOSKALJON, Veenendaal (NL); Gert BRONKHORST, Veenendaal (NL); Erinc KARATOPRAK, Veenendaal (NL); Jurgen HATHEIER, Veenendaal (NL)

(21) Appl. No.: 16/492,728

(22) PCT Filed: Mar. 15, 2018
(86) PCT No.: PCT/EP2018/056541

§ 371 Date: Sep. 10, 2019

(30) Foreign Application Priority Data
Mar. 17, 2017 (GB) 1704277.1

(51) Int. Cl. H04B 10/2575; H04B 10/25; H04B 10/69

(52) U.S. Cl. CPC H04B 10/25751; H04B 10/69; H04B 10/2589

(57) ABSTRACT

A method of segmenting an access network of a hybrid fiber coaxial network, the method comprising receiving optical signals at a main node converting the optical signals into digital signals associated with data and electrical signals associated with a broadcast spectrum, converting the digital signals into electrical signals in a frequency range differing from a frequency range of the broadcast spectrum electrical signals, producing a combined electrical signal with separate frequency bands for data and broadcast spectrum signals, and conveying the combined signal along a coaxial cable to a plurality of subsidiary nodes. Frequencies associated with a first Narrowcast band within the broadcast electrical spectrum signal are replaced with frequencies associated with a second Narrowcast band.

### FIELD OF THE INVENTION

This invention relates to a method of segmenting an access network of a hybrid fiber coaxial network, typically of the type used in broadband networks.

### BACKGROUND TO THE INVENTION

To improve the speed of data transfer in broadband and telecommunication networks, network providers are required to sub-divide their networks into smaller units so that smaller groups of users are connected to a common point, i.e. a node, allowing communication with the network provider.

The existing network infrastructure is already established and is extensive. Dividing or segmenting the access network through which each user communicates with a provider's head end is complicated by the need to use the existing infrastructure as much as possible so as to avoid excessive costs associated with installing extra signal transmission cables.

As most broadband networks are built as Hybrid Fiber Coax (HFC), the network dividing or segmentation is performed in the fiber optic domain. In many cases this means installing additional fiber cables to the network which is a large investment due to the labour cost. In addition, obtaining permits from local government can be a time consuming and long process. These factors in many cases delay the extension of the networks required to keep up with customer expectations and demands.

### SUMMARY OF THE INVENTION

In accordance with one aspect of the present invention, there is provided a method of segmenting an access network of a hybrid fiber coaxial network, the method comprising:

(i) receiving optical signals at a main node;

(ii) converting the optical signals into digital signals associated with data and electrical signals associated with a broadcast spectrum;

(iii) converting the digital signals associated with data into data electrical signals in a frequency range differing from a frequency range of the broadcast spectrum electrical signals;

(iv) producing a combined electrical signal with separate non-overlapping frequency bands for data electrical signals and broadcast spectrum signals, the frequency band associated with the data electrical signals extending up to at least 2 GHz; and

(v) conveying the combined electrical signal along a coaxial cable. Typically the optical signal includes signals associated with Ethernet and broadband spectrum, i.e. cable television (CATV) signals. Such a method allows unused bandwidth on a coaxial cable to be used to convey electrical signals, such as high frequency RF signals, associated with data.

The digital signals may comprise Ethernet signals and the broadcast spectrum electrical signals may comprise CATV signals.

Conversion of the data electrical signals to Ethernet signals is preferably achieved using an Ethernet over Coax (EOC) transceiver.

The combined electrical signal may be produced using a filter, such as a diplexer or triplexer, which is in turn connected to coaxial cables supplying multiple users.

The method may further comprise replacing frequencies associated with a first Narrowcast band within the broadcast spectrum electrical signals with frequencies associated with a second Narrowcast band, with typically generation of the second Narrowcast band typically taking place at a Remote PHY device. The first band of Narrowcast frequencies may be removed using a filter, such as a band stop filter.

The combined electrical signal may be conveyed to a plurality of subsidiary nodes, The subsidiary node may comprise a digital signal converter device, such as a PHY device, Remote PHY device or Remote MAC-PHY device. By sending a combined electrical signal having both data and broadcast spectrum components along the coaxial cable, a CATV access network is segmented or sub-divided into smaller units so that each subsidiary node is associated with far fewer households than the main node. This ensures that fewer households need to share the same bandwidth between where the household is connected to the network and the point where multiple households are combined at the subsidiary node.

The method may further comprise separating the data electrical signals from the broadcast spectrum electrical signals at each subsidiary node, removing frequencies associated with a first band of Narrowcast frequencies from the broadcast spectrum electrical signals, converting the data electrical signals to Ethernet signals, and converting the Ethernet signals into electrical signals incorporating a second band of Narrowcast frequencies.

The method preferably further comprises combining the electrical signals incorporating a second band of Narrowcast frequencies with the broadcast spectrum electrical signals from which the first band of Narrowcast frequencies has been removed and conveying the combined signal along coaxial cable to users.

The conversion of the electrical signals representing data to Ethernet signals may be achieved using an EOC transceiver.

The separation of the data electrical signals from the broadcast spectrum electrical signals is preferably achieved using a filter, such as a diplexer or triplexer.

A digital signal converter device may be used to convert Ethernet signals into electrical signals and also to generate a second Narrowcast band.

The data electrical signals are desirably bidirectional.

The method may further comprise auto-aligning a network to optimize signal transmission.

In accordance with another aspect of the invention, there is provided a broadband network using the method steps as discussed above.

The method is suitable for use in networks with bi-directional signal transmission between a head end and a user with the method steps describing downstream travel of the signal.

The invention will now be described, by way of example, with reference to the accompanying drawings in which:

FIG. 1 shows an example hybrid/fiber coax network;

FIG. 2 shows an example hybrid/fiber coax network using Remote PHY;

FIG. 3 shows an example architecture of a fiber node associated with multiple users;

FIG. 4 shows one embodiment of part of a network used for conveying digital data;

FIG. 5 shows the arrangement of FIG. 4 modified for conveying both CATV and digital data;

FIG. 6 shows an exemplary architecture of a hybrid/fiber coax network;

FIG. 7 shows a schematic diagram of a fiber node site; and

FIG. 8 shows a schematic diagram of a Remote PHY receiver site.

### DESCRIPTION

FIG. 1 shows a simplified schematic diagram of a broadband network 10 used to supply one or more of broadband, telecoms such as mobile phone and/or CATV, digital data and other signals to individual users. Signals pass bi-directionally between a head end 14 associated with the network provider through an access network 16 to a user 12.

Access network 16 consists of a fiber part 18 and a coax part 20 and is commonly referred to as a hybrid fiber coax network or “HFC network”. At the head end 14, digital data and video signals 22 are converted into RF electrical signals 24 that are in turn converted into optical signals 26. These optical signals are sent over an optical fiber ring 28 to reach an optical fiber node 30 where the optical signals are converted into RF electrical signals transmitted along coaxial cable 20 to homes and users 12. Where RF electrical signals from a home 12 pass along coaxial cable 20 to reach fiber node 30, node 30 converts the electrical signals to optical signals transmitted along optical fiber ring 28 to reach head end 14. Typically a plurality of fiber nodes are associated with fiber ring 28, each fiber node supplying multiple signal splitting devices, such as taps, and amplifiers so as to communicate with many user dwellings.

The network signal is initially sent over fiber because fiber has very low signal losses over long distances and so longer distances can be crossed without the need for amplifiers. However fiber is difficult to connect and to split and so where the signal needs to be split many times to connect to multiple users, the fiber is connected to coaxial cable instead.

In the past the average number of homes associated with each optical node was between 1000 and 2000 homes. However to improve speed of data transfer, smaller groups of users need to be associated with each optical node, with the aim being to have 250 or 125 homes connected to the main network via a single node. To achieve this, optical nodes need to be positioned closer to groups of users than at present and so extend over a greater distance. Given that the access network is usually buried in the ground, extending the fiber means digging which is slow and incurs labour costs.

Whilst fiber is used to cross long distances, analogue optical transmission causes distortion of the transported electrical signals. This distortion limits the options for transmitting higher speed data over the cable network. The only way to extend broadband speed and broadband upload/download capacity is to increase the signal quality and so to carry more data in a signal all distortions and noise need to be removed. Therefore systems have been developed to create the analogue signals after the fiber part of the network, see FIG. 2. In this arrangement, digital signals 22 are converted to optical signals 26 which are transmitted over optical fiber 28 and where fiber goes over into coax at fiber node 30, analogue RF electrical signals are generated by converting the optical signals into digital signals and then to electrical signals. Thus instead of undertaking the electrical signal conversion at head end 14, generation of the RF electrical signals occurs in access network 16.

This use of head end equipment at a location remote from the head end itself is known as Remote PHY or Remote Mac-PHY, the PHY chip or device located within fiber node 30 acting as a signal conversion interface. Remote PHY is a term covering all equipment that is usually placed in a head end but is instead positioned at a physical location Remote from the head end. However the same problem exists with Remote PHY in that to improve speed of data transfer, smaller groups of users need to be associated with each fiber node or optical node 30.

For the exemplary network shown in FIG. 3, 25 amplifiers 32 are connected to fiber node 30 to supply over 4000 homes. Ideally subsidiary access networks having their own fiber node want to be associated with amplifier 32′, amplifier 32″, amplifier 32′″ and amplifier 32″″ so as to ensure smaller groups of users are associated with each node and to ensure there are fewer customers sharing the bandwidth. If Remote PHY devices, adapted to operate as a node, are positioned at amplifier locations 32′, 32″, 32′″ and 32″″ access network 16 would be segmented or divided into multiple subsidiary access networks allowing much higher data transfer speed. However optical fiber would still need to be installed between each PHY device and main node 30 so as to enable digital data transfer from each PHY node to main node 30 to obtain the improvement in speed of transfer.

To improve data transfer and in one embodiment, coaxial cable 20 can be used to carry digital traffic simultaneously upstream and downstream without the need for installation of additional fiber optic cables, see FIGS. 4 and 6. Coaxial cable typically has a bandwidth of 0 to 4 GHz which can be used to create a data pipe for digital signals, providing a point-to-point link. This is achieved by converting optical digital signals conveyed along fiber 28 to electrical digital signals, or Ethernet signals, using optical to electrical converter 38, see FIG. 4, converting these Ethernet signals to high frequency RF analogue signals by modulation using receiver 40, such that the RF signals convey the digital data, and then restoring the Ethernet signals by demodulating at transmitter 42 and so supplying the Ethernet signals to digital to electrical conversion devices associated with users, such as Remote PHY 44, also shown in FIG. 6.

Each length of coaxial cable 20 is associated with an amount of signal loss and degradation. For coaxial cables of length in excess of 500 m, typically the RF analogue signal representing the digital data will need to be converted back to a digital signal partway along the length of cable 20 and then reconverted to an RF signal for onward transmission. This is to ensure that the signal does not become so distorted that the digital data is not retrievable at demodulator 42. Amplification is not possible due to the high frequencies used for this part of the signal and due to the bidirectional nature of this part of the RF signal, amplification only being possible for uni-directional signals. Thus typically at 500 m intervals along cable 20, a repeater stage 46 is provided in the form of a receiver or demodulator 48 connected to a transmitter or modulator 50. This allows the digital data to be retrieved or restored from the RF signal as a digital Ethernet signal without any loss of information before the digital data has become degraded, and then the digital Ethernet signal reconverted to an RF signal for onward transmission to the next demodulator, which may again be part of another repeater if necessary. For upstream signals, the same process will take place. If desired, the modulator and demodulator can be provided as a combined unit such as an EOC transceiver chip.

The arrangement can be used to convey only digital signals over an existing coaxial network. Alternatively it can be used for a CATV network transporting both CATV, or broadcast, signals and digital signals such as those from mobile telephones.

FIG. 5 shows an arrangement where both CATV and optical signals are supplied along fiber 28, which typically comprises many fibers and in this case is shown as fiber 28 supplying Ethernet signal and fiber 28′ supplying CATV signal to fiber optic node 30. At the node, the CATV data is converted into an analogue RF electrical signal in a first frequency range and the digital Ethernet signal is converted into an analogue RF electrical signal in a second higher frequency range. Optical to electrical converter 52 in node 30 converts the optical CATV signal into an RF analogue electrical signal with signals in a first frequency band labelled 1 and optical to electrical converter 54 converts the optical signal carrying digital data into a digital Ethernet signal which is then converted by modulator 56 into an RF analogue electrical signal with signals in at least one other discrete separate frequency band, and preferably at least two separate bands for upstream and downstream signals shown as bands 2 and 3. The first and second frequency ranges of the RF electrical signal representing the CATV signal and the digital data are discrete from each other and non-overlapping, with the second frequency range encompassing the digital data extending up to at least 2 GHz, and desirably to at least 3 GHz.

The analogue CATV signal and high frequency analogue RF signal representing the digital data, also referred to as data electrical signals, are combined at diplex filter into one frequency spectrum having separate frequency bands 1, 2 and 3. Where required due to signal losses or distortion, for example due to length of coaxial cable, the frequency spectrum is split back into analogue CATV signals and digital Ethernet signals at repeater stations 56 to ensure the digital data is preserved within the signal, as discussed in relation to FIG. 4, and which stations 56 are combined with an amplifier 62 for the CATV component of the RF signal. When the network reaches user homes, the higher frequency RF signals representing the digital data are converted back to digital Ethernet signals by demodulation, passed to a Remote PHY device and then recombined at a diplex filter with the analogue CATV signals to be is fed to user homes, typically using a tap.

In the network arrangement of FIG. 6, existing coaxial cable 20 in access network 12 is used to supply both CATV, i.e. broadcast spectrum, and data signals to Remote PHY devices 40 located where amplifiers 32′, 32″, 32′“, and 32″” were located in FIG. 3 so as to create segmentation into smaller subsidiary networks within access network 12 without the need to dig to install fiber. Remote PHY devices 40 act as a fiber node for data signals. Remote PHY devices 40 can incorporate an amplifier for broadcast signals or can be used in conjunction with existing amplifiers in access network 12. Coaxial cable 20 can be used to power devices and components within any of the networks described.

To achieve data conveyance by the coaxial cable, a data overlay procedure as described in relation to FIG. 5 takes place at fiber node site 30 which acts as a hub for the Remote PHY devices 44, 44′, 44″, 44′″ acting as nodes for each subsidiary network. All signals, such as broadcast spectrum/CATV signals and data signals, are combined on a common RF signal, forming discrete frequency bands within the frequency bandwidth provided by the coaxial cable, see FIGS. 5 and 7.

At fiber node 30, optical signals transmitted through fiber ring 28 are received and converted at optical to digital—electrical conversion point 70 into digital data signals in the form of high frequency 10 Gigabit Ethernet signals 72 obtained by coarse/dense wavelength division multiplexing and also converted into RF electrical signals 74 representing the low frequency broadcast CATV spectrum in a first frequency band 76 and which includes upstream signals, broadcast signals and Narrowcast signals designated by N1. Ethernet digital signal 72 is separated into data bands by Ethernet Over Coax transceiver 80 to create high frequency analogue electrical signals in a second discrete non-overlapping frequency range 82 which are passed to a filter, namely diplexer 84, to be combined with the analogue RF electrical signals 76 of the CATV broadcast spectrum. This produces an analogue electrical signal 90 having discrete non-overlapping frequency bands 76, 82 representing both the broadcast signals and the data signals. The upstream signals 92 will typically be within frequency band 0 to 85 MHz, Broadcast RF signals 94 in the range 125 to 600 MHz is and Narrowcast signals 96 in the range 600 to 860 MHz, and the Ethernet-derived electrical signals 98 typically in the range 1000 MHz up to at least 2 GHz. These frequency bands are given by way of example as they depend on system architecture but are selected to be discrete from each other and non-overlapping. For example, bands of up to 1220 MHz can be used for the CATV signals.

The digital signal bandwidth before entry into optical node 30, for example 10 Gigabit or 20 Gigabit, is available for allocation to the Remote PHY devices, or other devices accepting digital signals, connected to node 30. For long lengths of coaxial cable in excess of 500 m, using the modulators and demodulators with repeat stations as discussed in relation to FIG. 4 enables the bandwidth of 10 Gigabit to be preserved far downstream ready for use by digital to electrical conversion devices.

At the Remote PHY receiver site 100, see FIG. 7, the downstream part of combined signal 90 enters along coaxial cable 20 and passes into diplex filter 102 where it is separated into high frequency electrical signals 104 and low frequency broadcast spectrum electrical signals 106 which include Narrowcast signals N1 108. Band stop filter 110 is disposed between diplexer 102 and diplexer 112 along the signal path of RF electrical signal 106 and filters out Narrowcast signals 108 so that diplexer 112 receives broadcast spectrum signals without Narrowcast component N1.

High frequency signal 104 is passed to EOC transceiver 114 to be converted into 10 Gigabit Ethernet digital signal 116 which is passed to Remote PHY device 44 via switch 118. Switch 118 allows the signal to be temporarily blocked if needed, for example for maintenance. Transceivers 80, 114 function as modulators/demodulators and can be selected to increase speed of conversion and so reduce latency, i.e. signal delay, within the network. Reduced latency is of importance for networks where electronic gaming takes place.

Whilst the coaxial cable acting as a data pipe is described in relation to a CATV system, the general arrangement can be adopted for use in other coaxial systems, for example those conveying mobile telephone signals or other types of telecommunication signals with the Remote PHY device replaced with any device requiring a digital signal. If used in a CATV system, repeater stages can be located with amplifiers for the CATV network, each repeater stage demodulating the RF signal into an Ethernet signal and then remodulating the Ethernet signal into a high frequency RF signal carrying digital data with the amplifier amplifying the CATV signals. The CATV signals are at a lower frequency and typically in a bandwidth 0 Hz to 1220 MHz although other bandwidths can be used depending on system architecture.

At Remote PHY device 44, digital signal 116 is converted into an analogue electrical signal and a replacement Narrowcast signal N2 generated, such that Remote PHY generates an electrical signal 120 with high frequency components and also Narrowcast components N2 130 in the frequency gap between the high frequency signals 120 representing the original digital Ethernet data and the lower frequency broadcast signals. Typically for a CATV network the new Narrowcast components N2 will be in the frequency range 700 to 850 MHz. Electrical signal 120 with the new Narrowcast component N2 130 is recombined with the filtered broadcast RF electrical signal 106 at diplexer 112 for transmission over coaxial cable to users within the subsidiary network.

For upstream signals, data associated with analogue signal N2 will be converted into a digital Ethernet signal at Remote PHY 44 and then transmitted upstream.

By generating a new Narrowcast band, Remote PHY device 40 simulates a fiber node and so acts as a node for the subsidiary network of users associated with each PHY location site. This allows improved signal quality and so improved speed as the households previously associated with main fiber node 30 are now segmented over a number of nodes provided by the Remote PHY devices 40. Thus data and broadband signals can be carried over existing coax to feed Remote PHY devices which are used to segment the access network into a variety of subsidiary networks.

Each Remote PHY device can replace the Narrowcast signal it receives to replace it with an alternative Narrowcast signal. Thus in FIG. 6 Remote PHY 44 will remove is N1 and replace it with N2. The signal passing from Remote PHY 44 to Remote PHY 44′ will have N2 removed and replaced with N3 and at Remote PHY 44″, N3 will be removed and replaced with N4.

The network complies with the IEEE 1588v2 (PTP) timing protocol for signal synchronization and auto-aligns, with the modulators/receivers and demodulators/transmitters automatically communicating to auto-align and optimise signal transmission.

By adopting an unused part of the coaxial cable bandwidth to convey electrical signals associated with data, segmentation of an access network into subsidiary networks by Remote PHY devices or other digital to electrical signal converters can be achieved without disturbing the existing coaxial network and without the requirement to provide additional lengths of optical fiber. Existing networks are in most cases used to 860 or 1000 MHz and all electronic equipment is specified for that. The coaxial cables in the network are not limited to that frequency range and work perfectly up to frequencies of 3 GHz or higher. The embodiments shown use these frequency ranges to transport digital data using RF signals. A way of differentiating different data pipes to different locations via the existing coaxial cable is provided and so making a segmentation structure similar to an optical fiber arrangement.

Using the already installed base of coaxial cables saves installing fiber cables and reduces costs dramatically for the operator. It also reduces the time to market for the extended services and data speed the operator will be able to offer to his customers.

1. A method of segmenting an access network of a hybrid fiber coaxial network, the method comprising:
(i) receiving optical signals at a main node;
(ii) converting the optical signals into digital signals associated with data and electrical signals associated with a broadcast spectrum;
(iii) converting the digital signals associated with data into data electrical signals in a frequency range differing from a frequency range of the broadcast spectrum electrical signals;
(iv) producing a combined electrical signal with separate non-overlapping frequency bands for data electrical signals and broadcast spectrum signals, the frequency band associated with the data electrical signals extending up to at least 2 GHz; and
(v) conveying the combined electrical signal along a coaxial cable.

2. The method according to claim 1, wherein the digital signals comprise Ethernet signals and the broadcast spectrum electrical signals comprise CATV signals.

3. The method according to claim 1, wherein conversion of the digital signals is performed using an EOC transceiver.

4. The method according to claim 1, wherein the combined electrical signal is produced using a filter.

5. The method according to claim 1, wherein frequencies associated with a first Narrowcast band within the broadcast spectrum electrical signals are replaced with frequencies associated with a second Narrowcast band.

6. The method according to claim 5, wherein the first band of Narrowcast frequencies is removed using a filter.

7. The method according to claim 1, wherein the combined electrical signal is conveyed to a plurality of subsidiary nodes.

8. The method according to claim 7, further comprising separating the data electrical signals from the broadcast spectrum electrical signals at each subsidiary node, removing frequencies associated with a first band of Narrowcast frequencies from the broadcast spectrum electrical signals, converting the data electrical signals to Ethernet signals, and converting the Ethernet signals into electrical signals incorporating a second band of Narrowcast frequencies.

9. The method according to claim 8, further comprising combining the electrical signals incorporating a second band of Narrowcast frequencies with the broadcast spectrum electrical signals from which the first band of Narrowcast frequencies has been removed and conveying the combined signal along coaxial cable to users.

10. The method according to claim 8, wherein the conversion of the data electrical signals to Ethernet signals is achieved using an EOC transceiver.

11. The method of segmenting an access network according to claim 8, wherein separation of the data electrical signals from the broadcast spectrum electrical signals is achieved using a filter.

12. The method of segmenting an access network according to claim 8, further comprising using a digital signal converter device to convert Ethernet signals into electrical signals and also to generate a second Narrowcast band.

13. The method of segmenting an access network according to claim 1, wherein the data electrical signals are bidirectional.

14. The method of segmenting an access network according to claim 1, wherein the network auto-aligns to optimize signal transmission.

15. A broadband network using the method as set out in claim 1.
